(19) United States
(12) Patent Application Publication
(10) Pub. No.: US 2008/0028008 A1
(43) Pub. Date: Jan. 31, 2008

(54) Optical disc initiated data backup

(75) Inventors: Jeffrey Brunet, Richmond Hill (CA); Yousuf Chowdhary, Maple (CA); Ian Collins, Markham (CA)

Correspondence Address: CARR & FERRELL LLP, 2200 GENG ROAD, PALO ALTO, CA, 94303, US

(73) Assignee: Storage Appliance Corporation

(21) Appl. No.: 11/546,176

(22) Filed: Oct. 10, 2006

Related U.S. Application Data
(60) Provisional application No. 60/834,247, filed on Jul. 31, 2006.
(60) Provisional application No. 60/836,228, filed on Aug. 9, 2006.

(51) Int. Cl. G06F 17/30

(52) U.S. Cl. 707/204

(57) ABSTRACT

An optical disc comprising computer-readable instructions is provided. The computer-readable instructions include a backup application. When the optical disc is inserted into an optical drive of a data source, such as a personal computer, the operating system of the data source automatically launches the backup application. The backup application is configured to find files on the data source that satisfy search criteria, which can be predefined or user-selected. The backup application copies those files to a networked storage such as a storage area network or a server of a commercial service provider.

### CROSS-REFERENCE TO RELATED APPLICATIONS

This application claims the benefit of U.S. Provisional Patent Application No. 60/834,247 filed on Jul. 31, 2006 and entitled “A Portable Electronic Data Backup Appliance Utilizing a Hybrid Optical Disc” and U.S. Provisional Patent Application No. 60/836,228 filed on Aug. 9, 2006 and also entitled “A Portable Electronic Data Backup Appliance Utilizing a Hybrid Optical Disc.” This application is related to U.S. Non-Provisional patent application Ser. No. 11/546,263 filed on even date herewith and entitled “Optical Disc for Simplified Data Backup” which also claims the benefit of U.S. Provisional Patent Application No. 60/834,247, and U.S. Provisional patent Application No. 60/836,228. This application is related to, and incorporates by reference, U.S. Non-Provisional patent application Ser. No. 11/492,380 filed on Jul. 24, 2006 and entitled “Emulation Component for Data Backup Applications” which claims the benefit of U.S. Provisional Patent Application No. 60/725,225 filed on Oct. 12, 2005 and entitled “A Method, Apparatus and a System for Removable Media Device Emulation on an External Storage Device via an Emulation Component for the Purpose of an Electronic Data Backup Appliance,”U.S. Provisional Patent Application No. 60/814,687 filed on Jun. 19, 2006 and entitled “Portable Electronic Data Backup Appliance Based on Integrated Circuit (IC) Memory,” and U.S. Provisional Patent Application No. 60/817,540 filed on Jun. 30, 2006 and entitled “Portable Data Backup Appliance for Utilizing a Recordable Media Burner Dwevice.”

### BACKGROUND OF THE INVENTION

1. Field of the Invention

The present invention relates generally to the field of digital data management and more particularly to data backup applications.

2. Description of the Prior Art

Digital content, represented by digital data files of various file types, is rapidly replacing other forms of content. Documents, presentations, photos, movies, and music, for example, are increasingly produced and stored digitally. A problem for many individuals and organizations is that digital content, typically stored on a computer hard drive, can be poorly organized and needs to be archived to be protected against accidental loss. For example, digital photo files on a personal computer (PC) are likely to be found in numerous folders—photos transferred from a digital camera are stored in one set of folders, photos received as e-mail attachments are stored in other folders, and photos downloaded from websites are stored in still other folders.

One approach to archiving digital content is to periodically backup all of the data files on the computer, preserving the existing organizational structure. While this technique is effective to preserve digital content against accidental loss, the technique has several shortcomings. For one, the resulting copy is no better organized than the original, so misplaced or disorganized content remains misplaced or disorganized. Also, backing up all data files requires substantial memory capacity to copy numerous files that are otherwise already preserved elsewhere. Application specific files, for example, originally loaded onto the computer from a compact disc (CD) are already archived on the CD and therefore do not need to be backed up.

The necessary storage capacity for a complete backup can be obtained with writable data storage media, such as hard disc drives (HDDs), however, these require device installation and software set-up when first connected to a system. In order to complete these steps, a user may have to provide information about the existing system, which the user may not readily know. Also, the user may have to make decisions regarding the configuration of the device and the backup software. The number of steps involved with installation and set-up, as well as the complexity of some of the steps, dissuades many users from bothering with backup applications. The expense of a writable data storage media with enough capacity to perform a complete backup can also dissuade users from performing complete backups. Furthermore, some users, having bought and installed the necessary storage capacity, are dissuaded from performing frequent backups due to the length of time the system is tied up while performing a complete backup.

Alternately, a user can manually select a set of files from a directory and copy the selected files to a storage device. While this alternative may allow usage of a smaller memory device that does not require installation and set-up steps, manually selecting files is time-consuming. Also, manually selecting files creates the possibility of an accidental omission of some files.

Digital content can also be uploaded to an on-line storage service. On-line storage services provide several advantages including substantial storage capacities and the ability to access data files from remote locations. On-line storage services, for data backup purposes, not only fail to provide any automated backup applications, but also require significant user involvement to select an appropriate on-line storage system from the various alternatives, set up an account with the chosen system, configure the account with user identification, password, and payment information, select between various service options offered by the system, and so forth. Additionally, this approach suffers from many of the same drawbacks described above. A complete backup would still be no better organized than the original system, and depending on the data transmission rate for uploading files, may take an unreasonable length of time. A manually selected set of files would be just as time-consuming to determine, and just as likely to include accidental omissions.

What is needed, therefore, is the ability to selectively backup digital content in a manner that is both inexpensive and convenient.

### SUMMARY

An exemplary method for backing up data from a data source comprises detecting an optical disc in an optical drive of the data source, auto-launching a data backup application stored on the optical disc, and using the data backup application to copy a data file across a network to a networked storage. The networked storage can comprise, for example, a storage area network or a server of a commercial service provider. The commercial service provider can be predetermined, in some embodiments. The networked storage can also comprise a user-selected location. In some embodiments the method further comprises finding on the optical disc an Autorun.inf file that points to the data backup application. The method can also comprise finding the data file according to a criterion that can be predetermined or user-specified.

An exemplary data backup device comprises an optical disc comprising computer-readable instructions including auto launch instructions and a backup application. The auto-launch instructions are configured to point to the backup application and can comprise, in some embodiments, an Autorun.inf file. The backup application is configured to find data files on the data source according to a criterion, and back up the data files across a network to a networked storage. The criterion can be a type of content, and in some instances the criterion is pre-determined. The backup application can also be further configured to allow a user to specify the criterion. The networked storage can comprise, for example, a storage area network or a server of a commercial service provider. In some embodiments the commercial service provider is predetermined. The backup application can be further configured, in some embodiments, to allow a user to specify a location of the networked storage.

An exemplary business method is also provided. The business method comprises distributing an optical disc including computer-readable instructions, the computer readable instructions including a backup application configured to selectively back up data files from a data source to a server across the Internet. The method further comprises maintaining the server to store received data files and associate the stored files with the data source, and charging a fee based on the data files. In some embodiments the fee is charged for storing the data files, accessing the data files, or using the data files.

### BRIEF DESCRIPTION OF DRAWINGS

FIG. 1 is a top view of an exemplary optical disc according to an embodiment of the present invention.

FIG. 2 is a perspective view of an exemplary system comprising a data source with an internal optical drive and an attached external optical drive for receiving an optical disc according to an embodiment of the present invention.

FIG. 3 is a flow-chart representation of an exemplary method for backing up data files from a data source onto a writable portion of an optical disc according to an embodiment of the present invention.

FIG. 4 is a flow-chart representation of an exemplary method for backing up data files from the data source according to another embodiment of the present invention.

FIG. 5 is a flow-chart representation of an exemplary method for backing up data files from the data source according to still another embodiment of the present invention.

FIG. 6 is a flow-chart representation of an exemplary method for manipulating backed-up data files with the data source according to another embodiment of the present invention.

### DETAILED DESCRIPTION OF THE INVENTION

A data backup device is provided for personal, as well as commercial, applications. The data backup device of the present invention allows files to be selectively copied from a data source, such as a personal computer, to the data backup device according to some criterion such as file type. For example, the device can be configured to backup audio files having recognized music file extensions such as .mp3 and .wav, or image files having recognized image file extensions such as .jpg, .pct, and .tif. The data backup device stores a backup application that automatically launches when the data backup device is connected to the data source. The backup application can be configured to require little or no user input to perform the backup process. The data backup device can take the form of a hybrid optical disc divided into sections characterized by different media formats. Although the example of a hybrid optical disc is used for explanatory purposes herein, it will be appreciated that the invention is not limited to hybrid optical discs as is explained further herein.

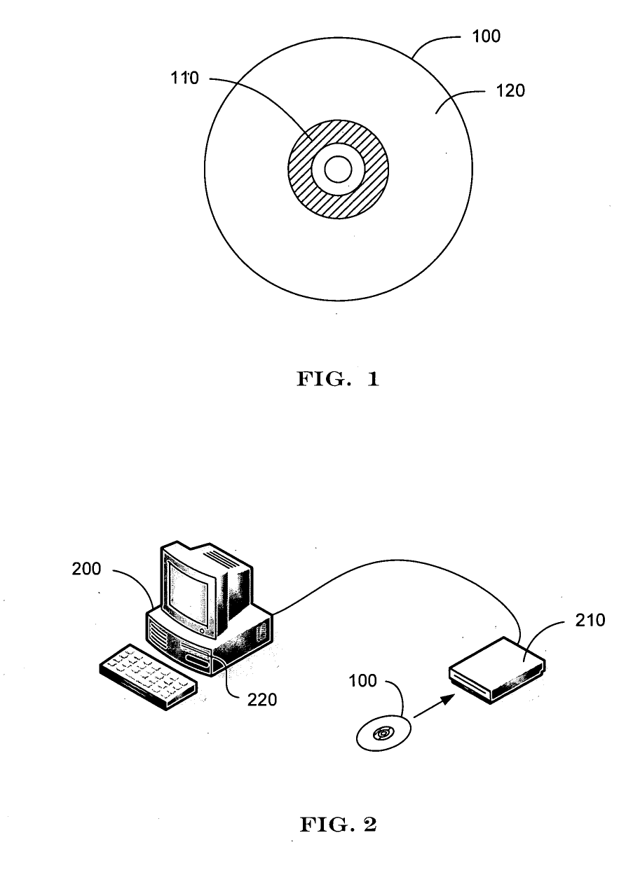

FIG. 1 provides a schematic representation of an optical disc 100 comprising two portions, a read-only portion 110 and a writable portion 120. The portions 110, 120 can comprise either the same or different media formats. The read-only portion 110 includes computer-readable instructions for backing up data onto the writable portion 120. These computer-readable instructions can include, for example, a backup application, a directory structure, system files, drivers, application programming interfaces (APIs), and other setup and configuration software.

As noted, the portions 110, 120 can comprise either the same or different media formats. In those embodiments where the portions 110, 120 of the optical disc 100 comprise the same media format, the media format is one that can only be written once. Examples of write-once media formats include Compact Disc-Recordable (CD-R), DVD-Recordable (DVD-R and DVD+R), DVD-Recordable Dual Layer (DVD-R DL and DVD+R DL), Blu-ray disc Recordable (BD-R), and High-Density Digital Versatile Disc (HD-DVD) formats. These media formats are defined in various industry standards known in the art such as the Orange Book Recordable Compact Disc Standard developed by Philips and Sony. In these embodiments, the read-only portion 110, having computer-readable instructions already written thereto, cannot be rewritten, whereas the writable portion 120 remains initially unwritten.

Optical discs 100 having portions 110, 120 comprising different media formats are referred to herein as hybrid optical discs. Where the optical disc 100 comprises a hybrid optical disc, suitable media formats for the read-only portion 110 include CD-ROM and DVD-ROM formats where the computer-readable instructions are placed on the read-only portion 110 by stamping. Other suitable media formats for the read-only portion 110 include the write-once media formats listed above where the computer-readable instructions are written to the read-only portion 110. In hybrid optical disc embodiments, the writable portion 120 can either comprise a write-once media format, or a rewritable media format such as Compact Disc-Rewritable (CD-RW), DVD-Rewritable (DVD-RW and DVD+RW), DVD-Rewritable Dual Layer (DVD-RW DL and DVD+RW DL), Blu-ray disc Re-writeable (BD-RE), and DVD Random Access Memory (DVD-RAM). The writable portion 120 can either be initially unwritten or, if the writable portion 120 comprises a rewritable format, can include computer-readable instructions that can be overwritten with data files.

It will be appreciated that the portions 110, 120 can also be distributed across the layers of a multi-layered optical disc 100. In one example, the read-only portion 110 is disposed on a first layer of a dual layer optical disc 100, such as a CD-ROM layer, and the writable portion 120 is disposed on a second layer, such as a DVD-R layer. As another dual layer example, both layers can comprise the DVD-R format with only a segment of a first layer comprising the read-only portion 110. In this example the remainder of the first layer, as well as a second layer, comprise the writable portion 120. In other embodiments, the different layers comprise different media formats, for instance, a triple layer optical disc 100 can comprise a CD-ROM layer, a DVD-R layer, and a DVD+R layer. In this example, the CD-ROM layer comprises the read-only portion 110 and the DVD-R and DVD+R layers comprise the writable portion 120. Providing both DVD-R and DVD+R formats on a single optical disc 100 can be particularly advantageous as many optical drives 210, 220 are configured to write to one of the two formats but not the other.

The following list provides examples of media format combinations that can be implemented for either a single-layer optical disc 100, where the two media formats are provided in a side-by-side configuration, or for a dual-layer optical disc 100 where the each media format is provided as a separate layer. Although the following list is extensive, the list is not meant to be exhaustive: CD-ROM/CD-R; CD-ROM/CD-RW; CD-ROM/CD+RW; CD-ROM/DVD-R; CD-ROM/DVD+R; CD-ROM/DVD-RW; CD-ROM/DVD+RW; CD-ROM/DVD+R DL; CD-ROM/BD-R; CD-ROM/BD-RE; CD-ROM/HD-DVD; DVD-ROM/DVD-R; DVD-ROM/DVD+R; DVD-ROM/DVD-RW; DVD-ROM/DVD+RW; DVD-ROM/DVD+R DL; DVD-ROM/BD-R; DVD-ROM/BD-RE; and DVD-ROM/HD-DVD-R. Additional media format combinations that can be implemented as the layers of a three-layer optical disc 100 include: CD-ROM/DVD-R/DVD+R; CD-ROM/DVD-RW/DVD+RW; DVD-ROM/DVD-R/DVD+R; DVD-ROM/DVD-RW/DVD+RW; CD-ROM/BD-R/HD-DVD-R; CD-ROM/BD-RE/HD-DVD-R; DVD-ROM/BD-R/HD-DVD-R; and DVD-ROM/BD-RE/HD-DVD-R. As above, this list of three-layer media format combinations is not meant to be exhaustive.

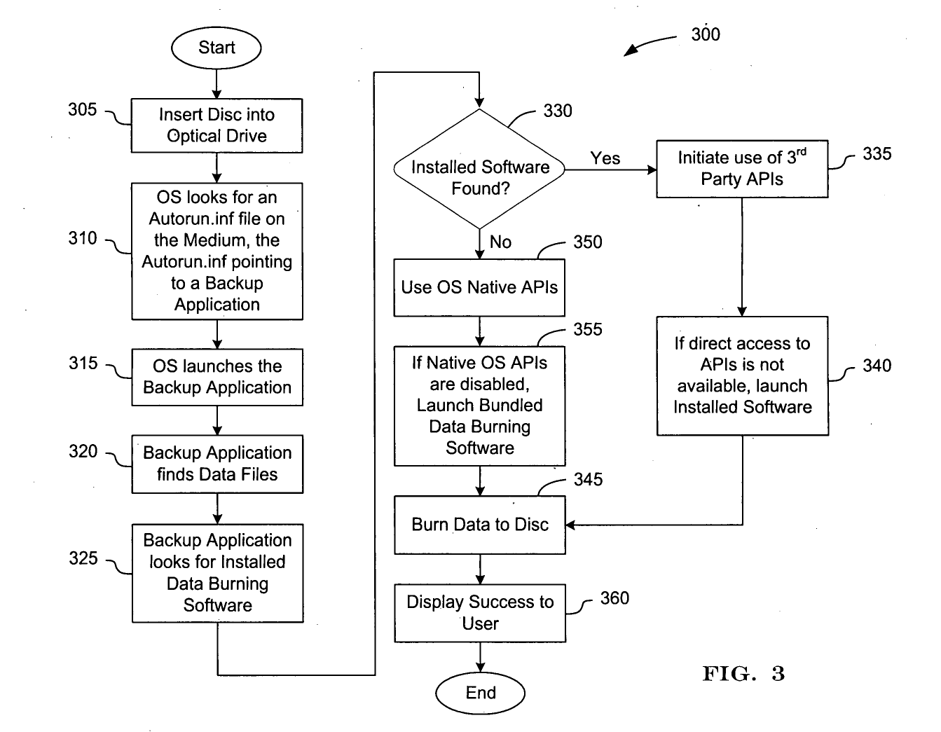

FIG. 2 shows a system comprising an exemplary data source 200 connected to an external optical drive 210 for reading from and writing to (i.e., “burning”) the optical disc 100. The data source 200 can alternatively or additionally include an internal optical drive 220 for the same purpose. Optical drives 210, 220 that have the ability to both read and write data are commonly referred to as “writers” or “burners.”

The data source 200 can be, for example, a personal computer (PC), a Macintosh computer (Mac), or a Personal Digital Assistant (PDA) on which data resides. The data source 200 can also comprise a server, a settop box, a television, a cellular telephone, a Smartphone, a digital still camera or video camera, a scanner, a digital music or video player, a game console, or a Personal Video Recorder (PVR). Preferably, the data source 200 includes an operating system (OS), such as Windows XP, that includes an automatic application launching function, as discussed in more detail elsewhere herein. Other suitable operating systems include MacOS, PalmOS, Linux, and Unix, for example. The data source, in some embodiments, can also be configured to access the Internet and/or include other peripheral devices (not shown), especially for data storage such as hard disc drives, solid state memory devices like compact flash (CF), and/or a storage area network (NAS).

As used herein, auto-launch devices are those devices that will trigger the automatic execution functionalities of certain operating systems, such as the AutoRun function of the Microsoft Windows operating systems. Examples of device types that will trigger AutoRun of Windows include CD and DVD drives when a CD or DVD medium is contained therein. In these examples, the Windows AutoRun functionality is triggered when either a CD or DVD medium is placed in either of the optical drives 210, 220, or when the optical drive 210, already containing a CD or DVD medium, is connected to the data source 200. The AutoRun function in Windows XP is used herein as merely an example of the automatic application launching functions that are made available by other operating systems, and the invention is not limited to the Windows environment.

FIG. 3 is a flow-chart representation of an exemplary method 300 for backing up data files from the data source 200 onto the writable portion 120 of the optical disc 100. The method 300 comprises inserting 305 the optical disc 100 into either of the optical drives 210 or 220. In this embodiment, the Windows operating system detects the insertion event and looks 310 for an Autorun.inf file on the optical disc 100, and more specifically, within the root directory of the computer-readable instructions on the read-only portion 110. In the example, the Autorun.inf file points to a backup application within the computer-readable instructions on the read-only portion 110. Because the backup application is listed in the Autorun.inf file, the Windows operating system automatically launches 315 the backup application to run on the data source 200.

The backup application finds 320 files that meet one or more predefined criteria, such as file type (e.g., .jpg) or type of content (e.g., audio files). The backup application can also find 320 files that meet at least one of several predefined criteria. Other examples of types of content include e-mails, business application data (e.g., Accpac and Simply Accounting files), digital video files, ebook files, contacts files, calendar files, text files, tasks files, settings files, bookmark files, and password files. Another criterion, in some embodiments, is whether a file has been previously backed up. Still other can be a particular date or a range of dates. The backup application, in some embodiments, finds 320 files that meet the predefined criteria by searching e-mail attachments and files embedded within other files, such as compressed files within a zip file. The backup application can find 320 files that are stored directly on the data source 200, or additionally on associated peripheral devices and networks.

One advantage of the invention is the simplicity of use of the optical disc 100 for selectively backing up a particular type of content, such as images or music. It will be appreciated that a user's involvement can be reduced to inserting 305 the optical disc 100 into either of the optical drives 210 or 220, and from that point forward the back-up method 300 continues automatically. Accordingly, the backup application can be configured to back up those data files that include a particular type of content, such as images. This allows embodiments of the optical disc 100 to be packaged and sold as a specialty data backup device for automatically backing up a single type of content onto the data backup device. In this way, the optical disc 100 can be viewed as a device that takes and stores a snapshot of a type of content on the data source 200. Additionally, a set of optical discs 100 can be provided together where each is a specialty data backup device dedicated to a different type of content such that the set covers the types of data files most commonly found on data sources 200. Thus, an exemplary set includes one optical disc 100 for backing up Microsoft Office files, one optical disc 100 for backing up music files, one optical disc 100 for backing up image files, and one optical disc 100 for backing up video files.

With continued reference to FIG. 3, the backup application looks 325 for installed data burning software and determines 330 whether installed data burning software is present. If already installed data burning software is present on the data source 200, the operating system initiates the use 335 of 3rd party Application Programming Interfaces (APIs). If direct access to the 3rd party APIs is not available, the installed software is launched 340. The files found 320 can then be written 345 by the installed software to the writable portion 120 of the optical disc 100. If installed software is not found, the Windows OS native APIs are used 350. If the Windows OS native APIs are disabled, bundled data burning software optionally included as part of the computer-readable instructions on the read-only portion 110 is launched 355 and the found files can then be written 345 by the bundled software. It will be understood that although looking 325 for installed data burning software is shown in FIG. 3 as sequentially following finding 320 files, looking 325 for installed data burning software and finding 320 files take place concurrently in some embodiments.

In some embodiments, writing 345 the files includes creating a file path or directory structure on the writable portion 120 to indicate the location where a copied file was located on the data source 200. In other embodiments, the backup application creates a new directory structure based on chronological order, alphabetical order, file size, or some other criteria. Another alternative is for the backup application to create a monolithic file that includes all of the backed up files. Yet another alternative is for the backup application to store on the writable portion 120 the backed-up files in a common directory (i.e., a flat structure) and to create an index (e.g. an XML index) that stores the information on file locations. In these embodiments, when the backed-up files are restored the index is used to re-create the directory structure on the data source 200.

As noted above, a user's involvement in the method 300 can be reduced to simply inserting 305 the optical disc 100 into either optical drive 210, 220. Once the backup application has successfully completed the data backup, a message indicating successful completion can be displayed 360 to the user by a graphical user interface (GUI) provided by the backup application on a display device of the data source 200. It will be understood, however, that other embodiments provide options to the user through the GUI so that the user, if desired, can customize the backup process prior to the backup application finding 320 data files. As one example, the user can customize the backup process by specifying one or more search criteria. The use can specify a search criterion by making a selection from a set of choices, for example, as presented in a drop-down menu. As another example, the user can customize the backup process by specifying one or more search criteria by entering the criteria in a text box. Additionally, the user can limit the scope of the backup process by drive, directory, folder, file type, file size, or date/time stamp, or the user can deselect a type of content or a specific file, drive, directory, or folder such as a temporary folder or an Internet Explorer directory. Additional user involvement is discussed below.

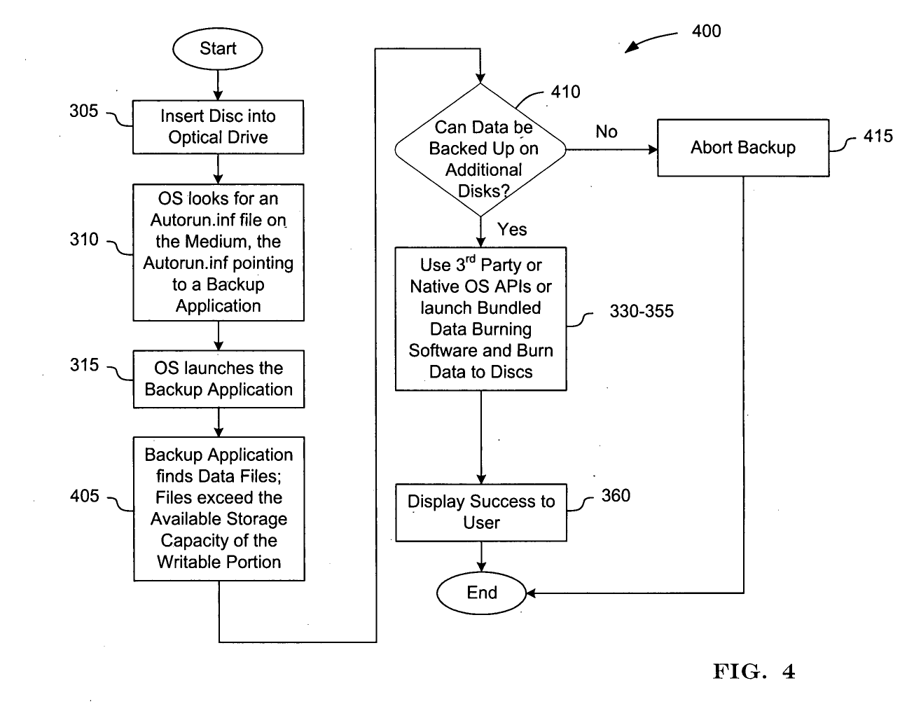

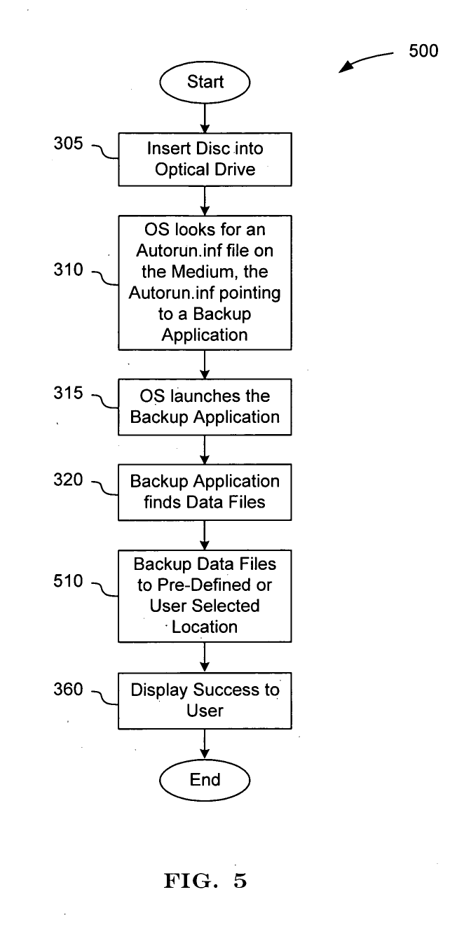

FIG. 4 is a flow-chart representation of another exemplary method 400 for backing up data files from the data source 200. The method 400 provides possible solutions for the situation where the found files on the data source 200 exceeds the storage capacity of the writable portion 120. The method 400 commences with inserting 305 the optical disc 100 into either of the optical drives 210 or 220. The Windows operating system looks 310 for the Autorun.inf file that points to the backup application. The Windows operating system launches 315 the backup application to run on the data source 200. The backup application finds 405 files that meet certain predefined criteria, however, in this instance the backup application determines that the storage capacity necessary to back up all of the found files exceeds the available storage capacity of the writable portion 120 of the optical disc 100.

At this point of the method 400, the backup application asks 410 whether the files can be backed up onto additional discs and waits for a response. If the user indicates that further discs are not available, the method 400 aborts 415 the backup. In an alternative embodiment, the backup application asks whether a subset of the found files should be backed up to the optical disc 100 to the extent possible given the limited storage capacity of the writable portion 120. If so, the backup application can provide the user alternatives for selecting the subset. For example, the user may select files in order of descending file size (thus omitting the smallest files), ascending file size (thus maximizing the number of files that are backed up), oldest to newest files or newest to oldest, by directory, and so forth.

If the user indicates that further optical discs are available, the method 400 continues with the process described above with respect to FIG. 3 from looking 325 for installed data burning software to writing 345 data to multiple discs. In the method 400 writing 345 data to the optical disc includes prompting the user to remove the optical disc 100 after the writable portion 120 is full, and to replace the optical disc 100 with another writable optical disc. Subsequent optical discs need not be the optical disc 100 of the invention. Replacing full optical discs with unwritten optical discs may be repeated until all of the found files are backed up, whereupon the backup application can display 360 a message indicating successful completion.

The further optical discs need not include the read-only portion 110 and can be any writable or rewritable optical disc that is compatible with the optical drive 210 or 220. In such a situation, the backup application marks with an internal label and sequentially numbers the optical disc 100 and the subsequent optical discs so that the user will be notified that the backed-up files span more than the optical disc 100 when the backed-up data is later accessed. In some instances the storage capacity needed to back up all of the found files is more than the available capacity of the writable portion 120, but less than the standard capacity of a blank optical disc. In this situation, the backup application can suggest a suitable media, for example, that the user insert a DVD-R where the files to be backed-up do not exceed the standard DVD-R capacity of 4.7 gigabytes (GB). The user can then opt to back up all of the found files to a single optical disc rather than distribute the found files between the writable portion 120 of the optical disc 100 and one or more additional optical discs.

It should be noted that the computer-readable instructions on the read-only portion 110 can include instructions that are installed onto the data source 200. In this way applications can run on the data source 200 even when the optical disc 100 is no longer present in either of the optical drives 210, 220. Thus, for example, embodiments of the present invention can also be configured to backup data based on a schedule, such as every 1^{st} day of every month, or according to internal or external triggers.

An example of an external trigger is the discretion of the user. When the user decides that a backup should be performed, the user can manually run the backup application. An example of an internal trigger is a threshold number of files on the data source 200. When the threshold is exceeded the backup application automatically begins finding files and copying them. This can include prompting the user to insert the optical disc 100, or another optical disc, into one of the optical drives 210, 220.

In either of the described methods 300 and 400, the backup application can employ known techniques for compression and encryption. Likewise, with respect to method 400, the backup application can employ known techniques for disc spanning where the storage capacity of the writable portion 120 is less than needed to store the found files. Also, in either of the described methods 300 and 400, should a backup fail or be incomplete, an informative message can be displayed to the user. The backup application can also be configured such that notifications to the user can be sent by e-mail alerts or network messages. Notifications can indicate that a backup failed, or that a backup was automatically performed successfully, for example.

FIG. 5 is a flow-chart representation of still another exemplary method 500 for backing up data files from the data source 200. The method 500 does not require the use of the optical disc 100 as the method 500 backs up the data files to storage options other than optical discs 100. The method 500 begins with inserting 305 an optical disc into either of the optical drives 210 or 220. In the method 500 the optical disc can be the optical disc 100, but can also be any optical disc that can be read by either of the optical drives 210 or 220 and that comprises computer-readable instructions including the backup application. For the purposes of method 500, the optical disc does not need to have a writable portion. In some embodiments, the optical disc including the computer-readable instructions is a CD-ROM or DVD-ROM.

As in the embodiments described above with respect to FIGS. 3 and 4, the Windows operating system looks 310 for the Autorun.inf file that points to the backup application. The Windows operating system auto-launches 315 the backup application to run on the data source 200. The backup application then finds 320 data files to be backed up. Next, the backup application backs up 510 the found data files to either a pre-defined location or a user-specified location. In the case of a user-specified location, the backup application prompts the user to specify a backup destination and waits for a response. The user can specify, for example, a network drive, an attached storage drive, a memory card, Network Attached Storage (NAS), and so forth. In some embodiments the user specifies the backup destination by selecting the backup destination from a drop-down menu or other list. Alternately, the user can enter the backup destination in a text box.

In some embodiments the backup application is configured to automatically direct the data files to be backed up to a pre-determined location, so that the user does not need to specify a destination. One example of a pre-determined location is a website accessible over the Internet. In such a case the data is automatically uploaded to the website. An online service provider, for example, can offer data storage as a service and distribute CD-ROMs including the backup application, where the backup application is configured to automatically direct data files to a URL maintained by the online service provider. The data files can then be stored, for instance, on servers maintained by the online service provider.

Payment for the storage service can be arranged in numerous different ways. As one example, the backup application asks the user to provide an e-mail address after the data files have been copied to the online service provider's servers. The online service provider can then send an e-mail to the user with pricing information based on the amount of storage used, for example, and requesting a credit card number for billing purposes. Rather than charge for the storage itself, the storage can be free but subsequent access or use can be billed. Examples of uses that can be billed for include printing copies of the data files, and where the data files are images, using the images in merchandising such as printing on T-shirts, coffee mugs, buttons, and so forth. In other embodiments, the backup application installs an access application on the data source 200. Launching the access application opens a browser such as Internet Explorer and directs the browser to the website of the online service provider. The online service provider can then charge the user for access to the data files.

Another example where the backup application can be configured to automatically direct the data files to be backed up to a pre-determined location is within the context of an organization, such as a corporation. For instance, an information technology (IT) department of a corporation can provide a backup application CD-ROM to each employee having a computer. The backup application can be configured to selectively back up business-related files such as e-mails and business application data. The data files are then directed to a specific drive on the corporation network that has been dedicated for this purpose. Advantageously, employees working remotely from the office can readily back up files.

Regardless of the destination for the data files, whether selected by the user or pre-determined, backing up 510 the data files proceeds as otherwise described with respect to FIG. 3 starting with looking 325 for installed data burning software. After completion, the backup application can display 360 a message indicating successful completion.

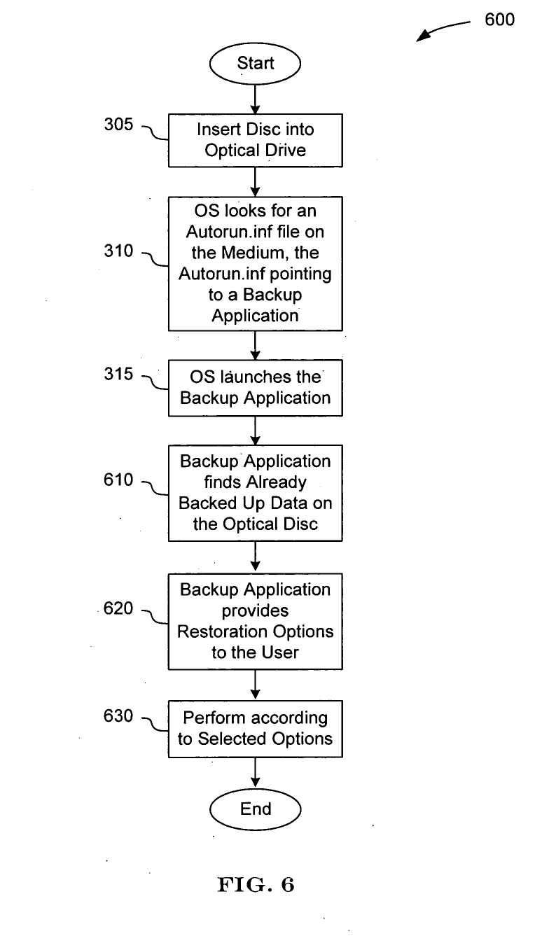

FIG. 6 is a flow-chart representation of an exemplary method 600 for manipulating backed-up data files with the data source 200. As in the previous methods 300-500, the method 600 commences with inserting 305 the optical disc 100 into either of the optical drives 210 or 220. The Windows operating system looks 310 for the Autorun.inf file that points to the backup application. The Windows operating system launches 315 the backup application to run on the data source 200. The backup application looks for backed-up data on the writable portion 120, and if such data is found 610, then the backup application provides 620 manipulation options to the user. In this way the user can opt to display the data files, restore the data to the data source 200, copy the data files to another storage device, share online, send by e-mail, print files, etc. After receiving the user options the backup application performs 630 the designated tasks. Although the above discussion describes the backup application as providing 620 manipulation options to the user, it will be understood that in the alternative, the backup application can launch another application to provide 620 manipulation options to the user.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for backing up data from a data source, the method comprising:
detecting an optical disc in an optical drive of the data source;
auto-launching a data backup application stored on the optical disc; and
using the data backup application to copy a data file across a network to a networked storage.

2. The method of claim 1 wherein the networked storage comprises a storage area network.

3. The method of claim 1 wherein the networked storage comprises a server of a commercial service provider.

4. The method of claim 3 wherein the commercial service provider is predetermined.

5. The method of claim 1 wherein the networked storage comprises a user-selected location.

6. The method of claim 1 further comprising finding on the optical disc an Autorun.inf file that points to the data backup application.

7. The method of claim 1 further comprising finding the data file according to a criterion.

8. The method of claim 7 wherein the criterion is pre-determined.

9. The method of claim 7 wherein the criterion is user-specified.

10. A data backup device comprising:
an optical disc comprising computer-readable instructions including auto launch instructions and a backup application, the auto-launch instructions configured to point to the backup application, the backup application configured to find data files on the data source according to a criterion, and back up the data files across a network to a networked storage.

11. The data backup device of claim 10 wherein the auto-launch instructions further comprise an Autorun.inf file.

12. The data backup device of claim 10 wherein the criterion is a type of content.

13. The data backup device of claim 10 wherein the criterion is pre-determined.

14. The data backup device of claim 10 wherein the backup application is further configured to allow a user to specify the criterion.

15. The data backup device of claim 10 wherein the networked storage comprises a storage area network.

16. The data backup device of claim 10 wherein the networked storage comprises a server of a commercial service provider.

17. The data backup device of claim 16, wherein the commercial service provider is predetermined.

18. The data backup device of claim 10 wherein the backup application is further configured to allow a user to specify a location of the networked storage.

19. A business method, comprising:
distributing an optical disc including computer-readable instructions, the computer readable instructions including a backup application configured to selectively back up data files from a data source to a server across the Internet;
maintaining the server to store received data files and associate the stored files with the data source; and
charging a fee based on the data files.

20. The business method of claim 19 wherein charging the fee based on the data files includes charging the fee for storing the data files.

21. The business method of claim 19 wherein charging the fee based on the data files includes charging the fee for accessing the data files.

22. The business method of claim 19 wherein charging the fee based on the data files includes charging the fee for using the data files.
